(19) United States
(12) Patent Application Publication
(10) Pub. No.: US 2020/0402332 A1
(43) Pub. Date: Dec. 24, 2020

(54) SYSTEM AND METHOD FOR IMPROVING THE REMOTE CONTROL OF HARDWARE

(71) Applicant: LIGHT WAVE TECHNOLOGY INC., St-Laurent (CA)

(72) Inventors: Robert NELSON, Westmount (CA); Jack WISNIA, Dollard-Des Ormeaux (CA); Feng DU, Kirkland (CA)

(21) Appl. No.: 17/009,162

(22) Filed: Sep. 1, 2020

Related U.S. Application Data
(63) Continuation of application No. PCT/CA2019/051445, filed on Oct. 10, 2019.
(60) Provisional application No. 62/746,285, filed on Oct. 16, 2018.

(51) Int. Cl. G07C 9/00; G06F 9/54; G06F 9/50; H04W 4/80

(52) U.S. Cl. CPC G07C 9/00309; G06F 9/547; G07C 2009/00769; G06F 9/541; H04W 4/80; G06F 9/5011

(57) ABSTRACT

A method for establishing a short-range wireless connection between a designated hardware component and a computing device such that a user's waiting time for using the computing device to send commands to the hardware component is reduced; it has configuring a short-range wireless receiver of the computing device to listen for an identity sequence generated by the hardware component; receiving the identity sequence specific to the hardware component; and generating a connection sequence for establishing the short-range wireless connection between the computing device and the hardware component; wherein the wireless connection between the computing device and the hardware component is maintained when an application program for remotely controlling the hardware component is brought to the foreground upon receiving user input from a user.

The present application claims priority from U.S. provisional patent application No. 62/746,285, filed on Oct. 16, 2018, incorporated herein by reference.

### TECHNICAL FIELD

The present disclosure relates to remote controlling hardware using a remote and a computing device in communication with the remote, and more particularly to remote vehicle systems configured to be remotely controlled by a smartphone.

### BACKGROUND

Remote vehicle starting and locking systems, keyless go systems and keyless start systems may be remotely controlled by a smartphone running an application program that is adapted to the remote vehicle system, provided that the smartphone is in range of the remote vehicle system such that a short-range wireless connection (e.g. Bluetooth connection) is established between the smartphone and the remote of the remote vehicle system.

However, with current remote vehicle systems and corresponding application programs running on a smartphone, the connection (i.e. pairing) between the smartphone and the remote of the remote vehicle system only occurs once the user provides input to cause the remote vehicle system to perform an action (e.g. start the vehicle, unlock the doors of the vehicle, etc.) or to run the corresponding application program on the smartphone. However, before the command can be issued, a short-range wireless connection has to be established between the remote and the smartphone. This causes unnecessary delay for the user (e.g. over ten seconds), who waits until the connection is established before the command is sent to the remote, actuating the remote vehicle system.

Therefore, it would be advantageous to have a remote vehicle system having a smartphone and a remote adapted to communicate with one another, such that an action could be performed by the vehicle following the receipt of user input provided to the smartphone, without having to wait for a short-range wireless connection to be established between the smartphone and the remote.

### SUMMARY

The present disclosure relates to an improved system for remotely actuating a hardware component (e.g. a remote vehicle system) that is configured to establish a short-range wireless connection between the smartphone and the remote adapted to control the hardware component, upon the smartphone coming into range of the remote. As such, because the short-range wireless connection is already established between the vehicle and the computing device, the commands inputted can be transmitted to the remote adapted to control the hardware component without the user having to wait until the short-range wireless connection is established between the computing device and the remote.

The application program stored in the memory of the computing device can cause a filter to be applied by the operating system that identifies identity sequences received by the receiver of the computing device that correspond to the remote.

Moreover, because the background application process of the computing device establishes a short-range wireless connection with the hardware component that is maintained for when the user would like to control the hardware component, or to receive notifications from the hardware component, this reduces the need of having a hardware component with an increased advertising rate (e.g. frequency of pings or identity sequences advertised) to establish rapidly a wireless connection when the computing device is in range of the hardware component. As such, as the advertising rate of the hardware component is reduced, this may also decrease the power consumption of the hardware component or its remote, while still establishing a usable short-range wireless connection between the computing device and the hardware component when the computing device is in a sufficient range of the hardware component to establish a short-range wireless connection.

A first broad aspect is a method for establishing a short-range wireless connection between a remote, for controlling a designated hardware component, and a computing device comprising a background process for causing the establishment of a short-range wireless connection with said remote, such that a user's waiting time for using the computing device to send commands to the remote is reduced. The method includes configuring a short-range wireless receiver of the computing device to listen to an identity sequence generated by the remote. The method includes receiving at a background process the identity sequence specific to the remote, indicating that the remote is in sufficient range of the computing device to establish the short-range wireless connection. The method includes generating by the background process a connection sequence for establishing the short-range wireless connection between the computing device and the remote, for transmission to the remote. The method includes bringing to the foreground an application interface of an application program for remotely controlling the hardware component upon receiving user input for running the application program.

In some embodiments, the short-range wireless receiver and the short-range wireless transmitter may be part of a short-range wireless transceiver of the computing device.

In some embodiments, the short-range wireless connection may be a Bluetooth connection.

In some embodiments, the hardware component may be a system for at least one of remote starting a vehicle, remote stopping the vehicle, unlocking the vehicle and locking the vehicle, and wherein the application interface may be adapted to receive input for at least one of remote starting the vehicle, remote stopping the vehicle, unlocking the vehicle and locking the vehicle.

In some embodiments, the hardware component may be a system for at least one of remote starting a vehicle and remote stopping the vehicle, and wherein the application interface may be adapted to receive input for at least one of remote starting the vehicle and remote stopping the vehicle.

In some embodiments, the background process may be a part of the application program for remotely controlling the hardware component.

In some embodiments, subsequent to establishing the short-range wireless connection, the method may include carrying out periodic connection handshaking with the remote to maintain the short-range wireless connection.

In some embodiments, the configuring a short-range wireless receiver of the computing device to listen to an identity sequence generated by the remote may be performed by using a filter at the level of the operating system of the computing device.

In some embodiments, the method may include receiving a message at said background process indicative of a property of said hardware component; and instructing an operating system of said computing device to generate a notification appearing on a display of said smartphone.

Another broad aspect is a system for establishing a short-range wireless connection between a remote, for controlling a designated hardware component, and a computing device comprising a background process for causing the establishment of a shot-range wireless connection with said remote, such that a user's waiting time for using the computing device to send commands to the remote is reduced. The system includes a background process stored in memory of the computing device, that, upon execution by a processor of the computing device, causes the processor of the computing device to: upon receiving an identity sequence generated by the remote, generate a connection sequence for establishing a short-range wireless connection with the remote, the connection sequence for transmission to the remote via a short-range wireless transmitter of the computing device. The system includes an application program for allowing a user to remotely control the hardware component using an application interface of the application program.

In some embodiments, the system may include the remote for actuating the hardware component comprising memory, a processor, a short-range wireless transmitter, a short-range wireless receiver; and program code stored in the memory of the remote that, when executed by the processor of the remote, causes the processor to generate periodically the identity sequence of the remote that is broadcast by the short-range wireless transmitter.

In some embodiments, the remote may be part of the hardware component.

In some embodiments, the remote may include an additional wireless transmitter, and wherein the system further comprises a receiver antenna adapted to be paired with the additional wireless transmitter of the remote.

In some embodiments, the remote may be separate from the hardware component.

In some embodiments, the short-range wireless receiver of the remote and the short-range wireless transmitter of the remote may be part of a short-range wireless transceiver of the remote.

In some embodiments, the computing device may include instructions of the application program stored in memory of the computing device, that when executed by the processor of the computing device, for causing the computing device to listen for the identity sequence generated by the remote and received by the short-range wireless receiver of the computing device, the identity sequence transmitted to the background process, and wherein the listening may be performed by generating a filter at a level of an operating system of the computing device.

In some embodiments, the short-range wireless connection may be a Bluetooth connection.

In some embodiments, the hardware component may be a remote starter unit of a vehicle, and wherein the application program is adapted to generate a command following the receipt of user input for causing the remote starting of the vehicle.

In some embodiments, the background process may be part of the application program.

Another broad aspect is a system for establishing a short-range wireless connection between a remote, for controlling a remote vehicle starting unit installed in a vehicle, and a computing device comprising a background process for causing the establishment of a short-range wireless connection with said remote, such that a user's waiting time for using the computing device to send commands to the remote is reduced. The system includes a remote for actuating the remote vehicle starting unit including memory; a processor; a first short-range wireless transmitter; a first short-range wireless receiver; a second wireless transmitter; and program code stored in the memory of the remote that, when executed by the processor of the remote, causes the processor to generate periodically an identity sequence of the remote that is broadcast by the first short-range wireless transmitter. The system includes an antenna, for installation in the vehicle, adapted to be paired with the second wireless transmitter of the remote. The system includes a background process stored in memory of the computing device, that, upon execution by a processor of the computing device, causes the processor of the computing device to, upon receiving an identity sequence generated by the remote, generate a connection sequence for establishing a short-range wireless connection with the remote, the connection sequence for transmission to the remote via a short-range wireless transmitter of the computing device. The system includes an application program comprising instructions stored in memory of the computing device and, when executed by the processor of the computing device, allows a user to remotely start the vehicle via the remote vehicle starting unit using an application interface of the application program; and causes the computing device to listen for the identity sequence generated by the remote and received by the short-range wireless receiver of the computing device, the identity sequence transmitted to the background process.

Another broad aspect is a method for establishing a short-range wireless connection between a designated hardware component and a computing device comprising a background process for causing the establishment of a short-range wireless connection with the hardware component, such that a user's waiting time for using the computing device to send commands to the hardware component is reduced. The method includes configuring a short-range wireless receiver of the computing device to listen for an identity sequence generated by the hardware component; receiving at a background process the identity sequence specific to the hardware component, indicating that the hardware component is in sufficient range of the computing device to establish the short-range wireless connection; and generating by the background process a connection sequence for establishing the short-range wireless connection between the computing device and the hardware component, for transmission to the hardware component; wherein the wireless connection between the computing device and the hardware component is maintained when an application program for remotely controlling the hardware component is brought to the foreground of the computing device upon receiving user input from a user.

In some embodiments, the short-range wireless receiver and the short-range wireless transmitter may be part of a short-range wireless transceiver of the computing device.

In some embodiments, the short-range wireless connection may be a Bluetooth connection.

In some embodiments, the hardware component may be a system for at least one of remote starting a vehicle, remote stopping the vehicle, unlocking the vehicle and locking the vehicle, and wherein the application interface may be adapted to receive input for at least one of remote starting the vehicle, remote stopping the vehicle, unlocking the vehicle and locking the vehicle.

In some embodiments, the hardware component may be a system for at least one of remote starting a vehicle and remote stopping the vehicle, and wherein the application interface may be adapted to receive input for at least one of remote starting the vehicle and remote stopping the vehicle.

In some embodiments, the background process may be a part of the application program for remotely controlling the hardware component.

In some embodiments, subsequent to establishing the short-range wireless connection, the method may include carrying out periodic connection handshaking with the hardware component to maintain the short-range wireless connection.

In some embodiments, the method may include receiving a message at the background process generated and transmitted by the hardware component; and may include instructing an operating system of the computing device to generate a notification appearing on a display of the smartphone in accordance with the received message.

In some embodiments, the hardware component may include a remote, and wherein the configuring may be configuring the short-range wireless receiver of the computing device to listen for an identity sequence generated by the remote of the hardware component; the receiving is indicative that the remote of the hardware component may be in sufficient range of the computing device to establish the short-range wireless connection; the generating may be for establishing the short-range wireless connection between the computing device and the remote of the hardware component, and the connection sequence is for transmission to the remote of the hardware component; and wherein the wireless connection between the computing device and the remote may be maintained when an application program for remotely controlling the hardware component through the remote is brought to the foreground upon receiving user input from a user.

Another broad aspect is a system for establishing a short-range wireless connection between a hardware component and a computing device such that a user's waiting time for using the computing device to send commands to the hardware component to control the computing device is reduced. The system includes a background process stored in non-transitory memory of the computing device, that, upon execution by a processor of the computing device, causes the processor of the computing device to: upon receiving an identity sequence generated by the hardware component, generate a connection sequence for establishing a short-range wireless connection with the hardware component, the connection sequence for transmission to the hardware component via a short-range wireless transmitter of the computing device; and an application program stored in the non-transitory memory of the computing device, that, upon execution by the processor of the computing device, causes the processor to allow a user to remotely control the hardware component using an application interface of the application program.

In some embodiments, the hardware component may include a remote, and wherein the generating may be for establishing a short-range wireless connection with the remote of the hardware component, the connection sequence may be for transmission to the remote of the hardware component via the short-range wireless transmitter of the computing device.

In some embodiments, the system may include the remote for actuating the hardware component, where the remote may include memory; a processor; a short-range wireless transmitter; a short-range wireless receiver; and program code stored in the memory of the remote that, when executed by the processor of the remote, causes the processor to generate periodically the identity sequence of the remote that is broadcast by the short-range wireless transmitter.

In some embodiments, the remote may be integrated in the hardware component.

In some embodiments, the remote may include an additional wireless transmitter, and the system may include a receiver antenna adapted to be paired with the additional wireless transmitter of the remote.

In some embodiments, the short-range wireless receiver of the remote and the short-range wireless transmitter of the remote may be part of a short-range wireless transceiver of the remote.

In some embodiments, the computing device may include instructions of the application program stored in memory of the computing device, that when executed by the processor of the computing device, may cause the computing device to listen for the identity sequence generated by the hardware component and received by the short-range wireless receiver of the computing device, where the identity sequence may be transmitted to the background process, and wherein the listening may be performed by generating a filter at a level of an operating system of the computing device.

In some embodiments, the short-range wireless connection may be a Bluetooth connection.

In some embodiments, the hardware component may be a remote starter unit of a vehicle, and wherein the application program may be adapted to generate a command following the receipt of user input for causing the remote starting of the vehicle.

In some embodiments, the background process may be part of the application program.

In some embodiments, the background process may cause the processor of the computing device to transmit, upon receipt by the background process of a message generated by the hardware component, instructions to an operating system of the computing device to generate a notification on a display of the computing device, the notification corresponding with the received message.

### BRIEF DESCRIPTION OF THE DRAWINGS

The invention will be better understood by way of the following detailed description of embodiments of the invention with reference to the appended drawings, in which:

FIG. 1 is a block-diagram of an exemplary computing device, an exemplary remote and an exemplary hardware component;

FIG. 2A is another block-diagram of an exemplary computing device, an exemplary remote and an exemplary hardware component;

FIG. 2B is a block-diagram of an exemplary computing device, an exemplary remote and an exemplary vehicle starting unit;

FIG. 2C is a block-diagram of an exemplary computing device and an exemplary stereo-system;

FIG. 3 is a flowchart diagram of an exemplary method performed by an exemplary computing device to establish a short-range wireless connection with an exemplary remote; and

FIG. 4 is a flowchart diagram of an exemplary method performed by an exemplary remote to establish a short-range wireless connection with an exemplary computing device; and

FIG. 5 is a flowchart diagram of an exemplary method for configuring a system for remotely controlling a hardware component.

### DETAILED DESCRIPTION

The present disclosure makes reference to a system for remotely actuating a remote vehicle system, such as a remote vehicle starter system, a keyless go system, a keyless start system, etc. (where the remote may be an original equipment manufacturer key, after-market key, etc.). However, it will be understood that the present disclosure may apply to other systems for remotely actuating a hardware component, such as remotely controlling a camera (e.g. a doorbell camera), a garage door, a thermostat, etc., where the hardware component is actuated directly or indirectly by a remote, the remote adapted to enter into communication with a computing device (e.g. smartphone) when the remote is in range of the computing device.

In the present disclosure, a “computing device”, may be a smartphone, desktop computer, a tablet computer, a smartwatch, a laptop, etc.

### Exemplary System for Remote-Controlling a Hardware Component

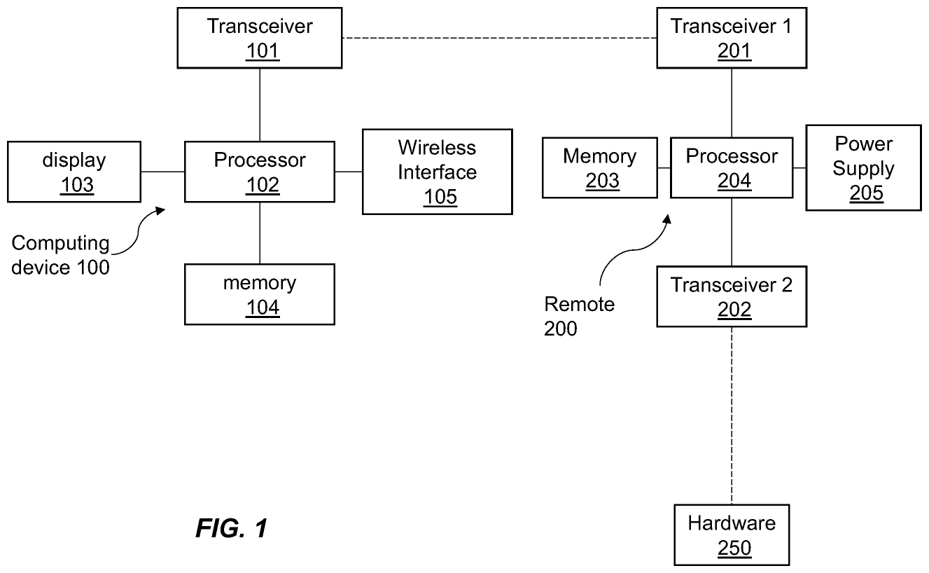

Reference is now made to FIG. 1, illustrating an exemplary system for remotely controlling a hardware component 250 (e.g. a remote car starting unit, a remote unlocking unit, etc.).

The hardware component 250 can be actuated by a remote 200. The remote 200 can be integrated to the hardware component 250, or can be separate from the hardware component 250 (when integrated, the remote 200—hardware component 250—may or may not have a transceiver 202 and/or an antenna 270).

A computing device 100 is adapted to enter into communication with the remote 200 when the computing device 100 is in range of the remote 200. A short-range wireless connection (e.g. Bluetooth connection, such as a BLE connection) is established between the computing device 100 and the remote 200 when the remote 200 is in range of the computing device 100, establishing a communication channel between the remote 200 and the computing device 100.

The computing device 100 has a processor 102 (e.g. a central processing unit), a memory 104 for storing instructions and program code executable by the processor 102, a short-range wireless transceiver 101 (or a short-range wireless receiver and a short-range wireless transmitter). The computing device 100 may have a display 103 and a wireless interface 105 for, e.g., establishing a long-range wireless connection (e.g. over the Internet).

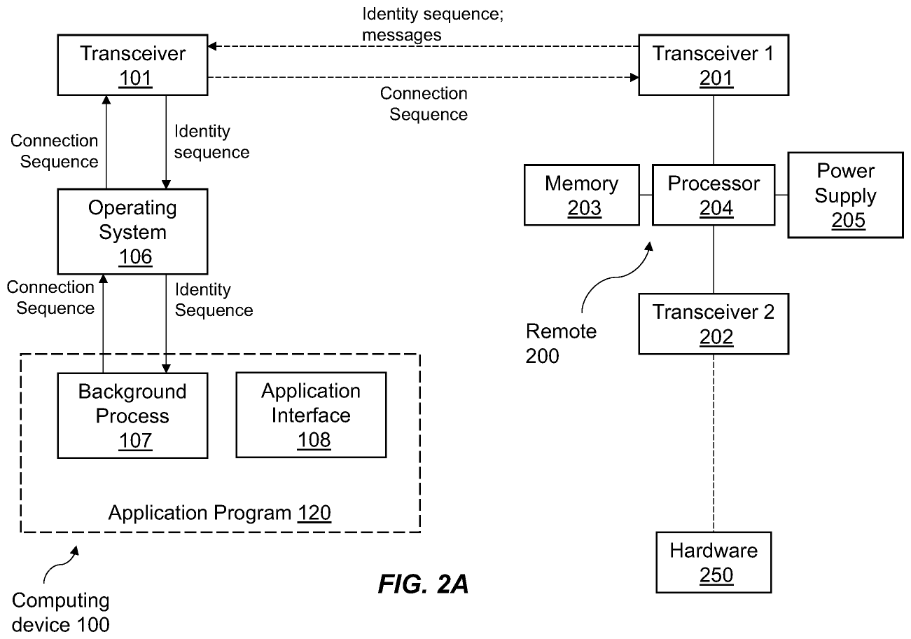

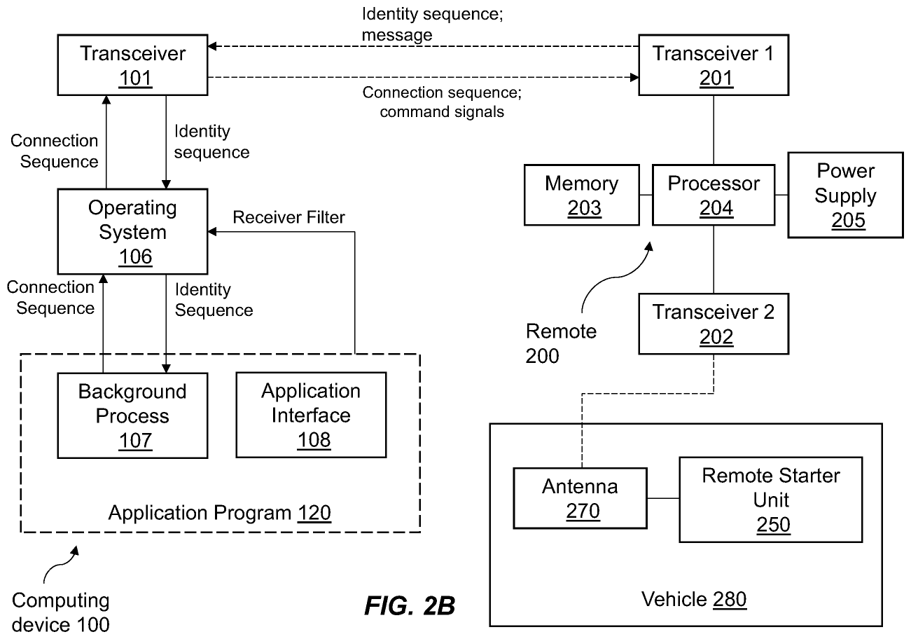

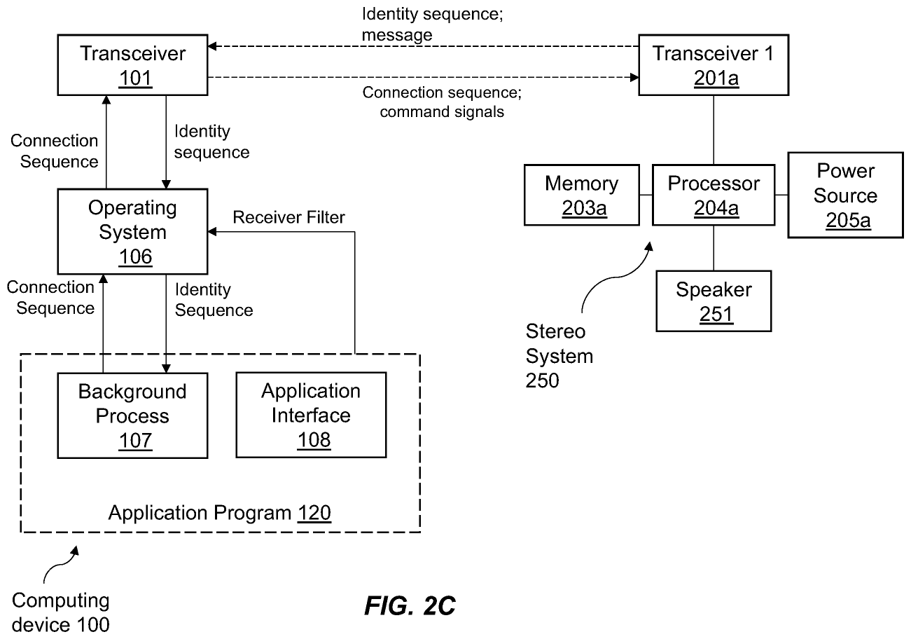

The remote 200 may have a processor 204 (e.g. a microprocessor), memory 203 for storing instructions (e.g. program code) that are executable by the processor 204, a power supply 205 (e.g. a battery, a connection with an external power source, etc.) and a short-range wireless transceiver 201 (or a short-range wireless receiver and a short-range wireless transmitter) for establishing a short-range wireless connection with the smartphone 100. In some embodiments, the remote 200 may also have a wireless transceiver 201 (or a wireless receiver and wireless transmitter) for establishing a wireless connection with the hardware component 250 (or the antenna 270 as shown in FIG. 2B), where the hardware component 250 may be actuated by the remote 200 via the wireless connection established between the hardware component 250 and the remote 200. The wireless connection between the remote 200 and the hardware component 250 (or the antenna 270) may be short-range or long-range (where the distance separating the remote 200 and the hardware component 250 or antenna 270 may be, e.g., one mile or more). In other embodiments, the remote 200 may have a wired connection with the hardware component 250, where the hardware component 250 may be actuated by the remote 200 via the wired connection established between the hardware component 250 and the remote 200.

The hardware component 250 may cause another hardware component to perform an action. For instance, the hardware component 250 may be a remote starting unit installed in a vehicle for causing the vehicle to start upon the hardware component 250 being actuated directly or indirectly by the remote 200.

Reference is now made to FIGS. 2A and 2B, illustrating a system for remotely actuating a hardware component, whereupon a short-range wireless connection is established between the remote 200 and the smartphone 100 once the smartphone 100 is in range of the remote 200, such that the user does not have to wait for the short-range wireless connection to be established prior to having the issued commands actuate the hardware component.

The computing device 100 has an operating system 106 stored as program code in memory 104, and executable by the processor 102.

The computing device 100 also has an application program 120 stored in memory 104 of the computing device 100. The application program 120 may provide an application interface that can run in the foreground to allow a user to provide input for remotely controlling the hardware component 250 using the computing device 100.

The application program 120 may also include instructions, stored in memory 104, that when executed by the processor 102 (and, e.g., after the computing device 100 is restarted or the application program 120 is run in the foreground) that causes the processor to generate a filter that causes the O.S. 106 to identify specific identity sequences issued by the remote 200 and received by the transceiver 101, thereby filtering out other identity sequences received by the transceiver 101. The filtered identity sequence is then transmitted by the O.S. 106 to the background process 107.

A background process 107 (running behind the scenes without user intervention) is also stored in memory 104 of the computing device 100 that is related to the remote 200 and/or the hardware component 250. The background process 107 may be part of the application program 120, or may be a standalone process or an application program. In some examples, the background process 107 may be associated with a service running on the computing device 100 for establishing a short-range wireless connection with a nearby device (e.g. a Bluetooth connection).

The background process 107 includes program code stored in memory 104 that is executable by the processor 102 to receive an identity sequence generated by the remote 200, captured by the transceiver 101, and transmitted by the O.S. 106. Upon receipt of the identity sequence, the background process 107 may verify the identity of the remote 200. The background process 107 may include instructions stored in memory 104 that, when executed by the processor 102, (e.g. following verification of the remote 200) cause the generation of a connection sequence (e.g. a challenge) that may be transmitted to the remote 200 (via the O.S. 106) using the transceiver 101 (or a transmitter). The challenge may be one as is known in the art for establishing a connection (e.g. initiating a handshake) between a smartphone and a remote.

FIG. 2B relates specifically to an application where the hardware component 250 is a remote vehicle starter unit. The remote vehicle starter unit 250 is installed in the vehicle 280, where the remote vehicle starter unit 250 can start or turn off the motor of the vehicle 280 as is known in the art.

In some embodiments, a receiver antenna 270 may also be installed in the vehicle 280. The receiver antenna 270 is configured to receive a command signal from the transceiver 202 for actuating the remote vehicle starter unit 250. As such, the receiver antenna 270 may be paired with the transceiver 202. The receiver antenna 270 may be a short-range receiver or a long-range receiver. The connection between the receiver antenna 270 and the remote vehicle starter unit 250 may be a wired connection.

### Exemplary Computing Device in Communication with an Exemplary Stereo System

In some embodiments, the computing device 100 may be in communication with a hardware component 250 that does not have a remote 200. Reference is made to FIG. 2C, illustrating an exemplary embodiment where the hardware component 250 is a stereo system, and where no remote 200 that is communicating with the computing device 100 is present. The stereo system 250 is configured to receive remote instructions generated from an application program 120 running on the computing device 100, the application program 120 used by the user for controlling the stereo system 250. The application program 120 is adapted for communication with the stereo system 250.

An exemplary stereo system 250 may have a processor 204a, memory 203a, a power source 205a (e.g. battery; connection to power outlet) and a speaker 251. The stereo system 250 also has a transceiver 201a for establishing a short-range wireless connection with the computing device 100.

The short-range connection between the stereo system 250 and the computing device 100 is established in accordance with the present teachings when the computing device 100 comes into range with the stereo system 250.

Once the short-range wireless connection is established between the stereo system 250 and computing device 100, the user may use the application program 120 to send instructions to the stereo system 250 for controlling the stereo system 250 (e.g. play a given radio station; stream music to the stereo system 250; adjusting volume of the stereo system 250, etc.)

Moreover, the stereo system 250 may also send notifications, via the short-range wireless connection, to the computing device 100. The notifications are received by the background process 107. The background process 107 receives the notification messages and transmits the notification messages to the operating system 106 for display by the operating system 106 on the display of the computing device 100. Such notifications may include, e.g., that the battery of the stereo system 250 is low, that a new musical genre is playing, the track name, etc.

### An Exemplary Method Performed by the Computing Device for Establishing a Short-Range Wireless Connection with the Remote

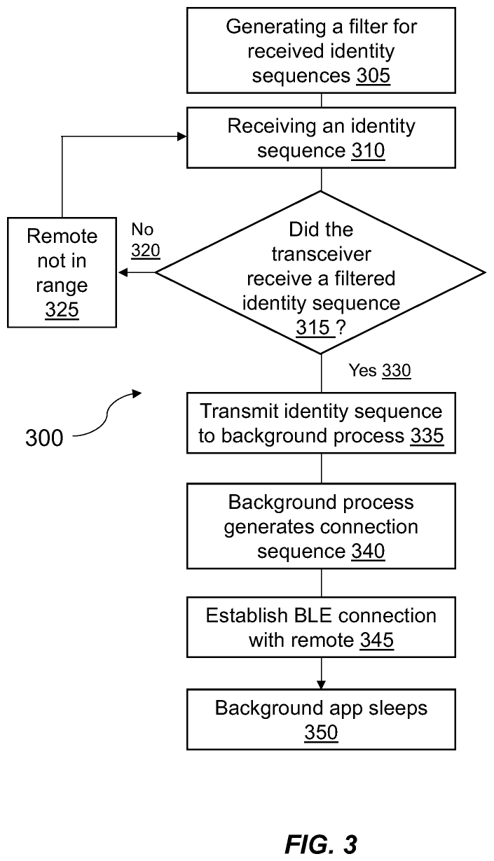

Reference is now made to FIG. 3, illustrating an exemplary method 300 performed by a computing device 100 for establishing a short-range wireless connection with a remote 200, such that the connection may be made prior to a user providing input for causing the actuation of the hardware component 250. As such, the user does not have to wait for the connection to be established between the computing device 100 and the remote 200 when the user provides input to actuate the hardware component 250.

The application program 120 includes program code stored in memory 104 that, when executed by the processor 102, causes the O.S. 106 and the transceiver 101 to listen for identity sequences specifically generated by the remote 200 at step 305. For instance, the application program 120 may generate a filter for identifying identity sequences generated by the remote 200 (that may be set after the application program 120 is run, or when the computing device 100 is restarted, or turned on and off).

The transceiver 101 may receive the identity sequence of the remote 200, e.g., broadcast over a publicly known channel (e.g. a BLE channel) at step 310.

The O.S. 106 and the transceiver 101, adapted to listen for the identity sequence of the remote 200, may verify the identity sequence of the remote 200 at step 315.

If the identity sequence is not that of the remote 200, at step 320, this is indicative of the remote 200 not being in range at step 325. The O.S. 106 (and the transceiver 101) may then continue to listen for an identity sequence generated by the remote 200 at step 315.

If the identity sequence is identified as being generated by the remote 200 at step 330, the identity sequence is transmitted to the background process 107 at step 335.

After receiving the identity sequence (in some examples, the background process 107 may verify the identity sequence received from the remote 200), the background process 107 generates a connection sequence (e.g. a challenge for establishing a handshake with the remote 200) at step 340 for causing a short-range wireless connection to be established between the computing device 100 and the remote 200. The connection sequence is one as is known in the art for establishing a handshake with the remote 200, where, e.g., the remote accepts the user ID of the logged user.

The connection sequence is transmitted to the remote, via the O.S. 106, using the transceiver 101, now that the computing device 100 is in range of the remote 200, over the short-range wireless connection.

Upon completion of the challenge, a short-range wireless connection is established between the computing device 100 and the remote 200 at step 345. This short-range wireless connection may be maintained provided that the computing device 100 and the remote 200 remain in range.

The background process 107 may remain dormant as the short-range wireless connection has been established at step 350.

The short-range wireless connection is therefore established between the computing device 100 and the remote 200, such that, when the user provides input using the application interface 108 of the application program 120, the user does not have to wait for the short-range wireless connection to be established prior to sending out the command signal or data to the remote 200 for causing the actuation of the hardware component 250.

In some embodiments, the computing device 100 may initiate periodic handshaking with the remote 200 to maintain the short-range wireless connection with the remote 200.

### An Exemplary Method Performed by the Remote for Establishing a Short-Range Wireless Connection with the Computing Device

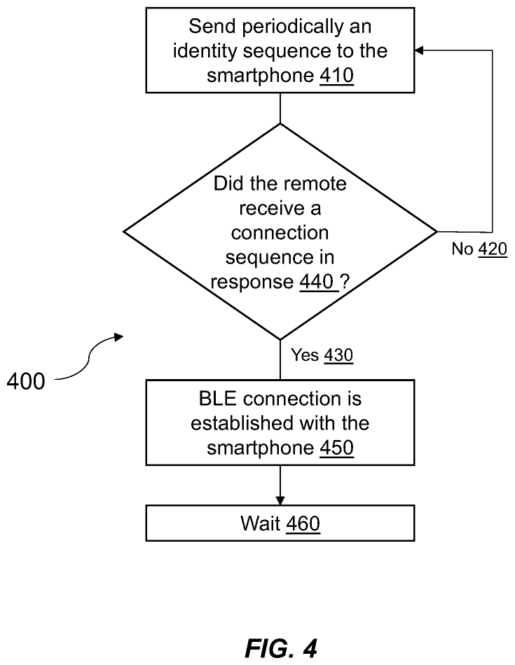

Reference is now made to FIG. 4, illustrating an exemplary set of steps 400 carried out by the remote 200 for causing a short-range wireless connection to be established between the remote 200 and the computing device 100 when the remote 200 is in sufficient range of the computing device 100 for establishing the short-range wireless connection.

The remote 200 may be configured (have program code stored in memory of the remote and when executed by the processor of the remote) to periodically generate and broadcast an identity sequence over the short-range wireless transceiver 201 (or transmitter) at step 410.

In some examples, the remote 200 may verify, or act depending on the receipt of a connection sequence from the computing device 100 generated by the computing device 100 after the computing device 100 received the identity sequence broadcast by the remote 200 at step 440.

If the remote 200 did not receive a connection sequence from the computing device 100 at step 420, the remote 200 continues to periodically generate and broadcast the identity sequence at step 410.

However, if the remote 200 did receive a connection sequence (e.g. challenge) from the computing device 100 at step 430, the remote 200 may carry out the challenge and establish the short-range wireless connection with the computing device 100 at step 450, and may stop generating and broadcasting the identity sequence.

The remote 200 may then wait at step 460 until the remote 200 receives a command signal or command data from the computing device 100 (e.g. smartphone) transmitted over the short-range wireless connection for causing the actuation of the hardware component 250 via the remote 200.

It will be understood that if the short-range wireless connection (e.g. the paired connection) between the computing device 100 and the remote 200 is lost (e.g. because the computing device 100 and the remote 200 are out of range), then the remote 200 may begin again generating and broadcasting identity sequences, as described in step 410.

### Generating Notifications on the Computing Device

In some examples, the remote 200, separate or integrated to the remote starter unit 250, may be configured to, once the wireless connection is established between the remote 200 and the computing device 100, generate messages or notifications sent over the wireless connection to the transceiver 101 of the computing device 100. The messages may, for instance, provide information as to the status or condition of the vehicle, such as, for instance, that the vehicle has reached a given temperature, that the vehicle is on/off, that the front lights of the vehicle are on, that a door of the vehicle is unlocked, that the trunk of the vehicle is open, etc. The message may also be a notification that the vehicle is in range with a user who has possession of the computing device 100.

In some examples, the remote starter unit 250, the remote 200, may include additional sensors to detect certain changes in the properties of the vehicle 280 (e.g. a temperature sensor for detecting the temperature of the vehicle 280, a proximity sensor to detect if a door is open, etc.) In other embodiments, the remote starter 250, or the remote 200, may be connected or may receive information from components of the vehicle 280 (e.g. temperature sensor) that can detect a change in the property of the vehicle 280.

In some embodiments, the message may be transmitted via the antenna 270 to transceiver 202. In turn, transceiver 201 may transmit the message to the transceiver 101 of the computing device 100.

In other embodiments where the remote 200 is part of the remote starter unit 250, the message may be transmitted directly from the transceiver 201 to the transceiver 101 of the computing device 100.

Upon receipt of the message by the transceiver 101, the message is transmitted to the background process or service 107 (e.g. of short-range wireless connection service (e.g. Bluetooth service) or of the application program 120). The background process 107 receives the message and instructs the operating system 106 of the computing device 100 to generate a notification on the display of the computing device 100 corresponding to the message.

For instance, if the message received by the background process 107 is indicative of the vehicle 280 reaching a given temperature, then the notification, appearing on the display of the computing device 100, may be “Vehicle at 20° C.”. It will be understood that other notifications may appear on the display of the computing device 100 in accordance with the message received from the background process 107 without departing from the present teachings.

### An Exemplary Method of Configuring a System for Controlling Remotely a Hardware Component

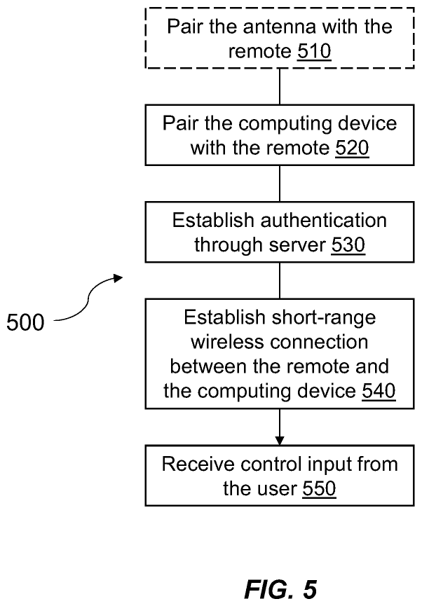

Reference is now made to FIG. 5, illustrating an exemplary set of steps 500 for configuring a remote-control system for remotely controlling a hardware component.

Optionally, when a receiver antenna 270 is provided that is connected or connectable to the remote starter unit 250, the antenna 270 may be paired with the remote 200 at step 510.

The computing device 100 may also be initially paired with the remote 200 at step 520.

When a user runs the application program 120 on the computing device 100, the user's identity or credentials may be authenticated through a server at step 530.

A short-range wireless connection is then established between the remote and the computing device 100 as described herein at step 540, such that command signals/command data can be transmitted from the computing device 100 to the remote 200.

The computing device 100 can then receive command input from a user at step 550, that can be provided on an application interface 108, that results in the generation of command signals/command data that are sent over the short-range wireless connection to the remote 200 for causing the actuation of the hardware component 250.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method for establishing a short-range wireless connection between a designated hardware component and a computing device comprising a background process for causing the establishment of a short-range wireless connection with said hardware component, such that a user's waiting time for using the computing device to send commands to the hardware component is reduced, comprising:
configuring a short-range wireless receiver of said computing device to listen for an identity sequence generated by said hardware component;
receiving at a background process said identity sequence specific to said hardware component, indicating that said hardware component is in sufficient range of said computing device to establish said short-range wireless connection; and
generating by said background process a connection sequence for establishing said short-range wireless connection between said computing device and said hardware component, for transmission to said hardware component;
wherein the wireless connection between said computing device and said hardware component is maintained when an application program for remotely controlling said hardware component is brought to the foreground of said computing device upon receiving user input from a user.

2. The method as defined in claim 1, wherein said short-range wireless receiver and said short-range wireless transmitter are part of a short-range wireless transceiver of said computing device.

3. The method as defined in claim 1 or claim 2, wherein said short-range wireless connection is a Bluetooth connection.

4. The method as defined in any one of claims 1 to 3, wherein said hardware component is a system for at least one of remote starting a vehicle, remote stopping said vehicle, unlocking said vehicle and locking said vehicle, and
wherein said application interface is adapted to receive input for at least one of remote starting said vehicle, remote stopping said vehicle, unlocking said vehicle and locking said vehicle.

5. The method as defined in claim 4, wherein said hardware component is a system for at least one of remote starting a vehicle and remote stopping said vehicle, and wherein said application interface is adapted to receive input for at least one of remote starting said vehicle and remote stopping said vehicle.

6. The method as defined in any one of claims 1 to 5, wherein said background process is a part of said application program for remotely controlling said hardware component.

7. The method as defined in any one of claims 1 to 6, subsequent to establishing said short-range wireless connection, further comprising carrying out periodic connection handshaking with said hardware component to maintain said short-range wireless connection.

8. The method as defined in any one of claims 1 to 7, further comprising:
receiving a message at said background process generated and transmitted by said hardware component; and
instructing an operating system of said computing device to generate a notification appearing on a display of said smartphone in accordance with said received message.

9. The method as defined in any one of claims 1 to 8, wherein said hardware component comprises a remote, and wherein:
said configuring is configuring said short-range wireless receiver of said computing device to listen for an identity sequence generated by said remote of said hardware component;
said receiving is indicative that said remote of said hardware component is in sufficient range of said computing device to establish said short-range wireless connection;
said generating is for establishing said short-range wireless connection between said computing device and said remote of said hardware component, and said connection sequence is for transmission to said remote of said hardware component; and
wherein said wireless connection between said computing device and said remote is maintained when an application program for remotely controlling said hardware component through said remote is brought to the foreground upon receiving user input from a user.

10. A system for establishing a short-range wireless connection between a hardware component and a computing device such that a user's waiting time for using the computing device to send commands to the hardware component to control the computing device is reduced, comprising:
a background process stored in non-transitory memory of said computing device, that, upon execution by a processor of said computing device, causes said processor of said computing device to:
upon receiving an identity sequence generated by said hardware component, generate a connection sequence for establishing a short-range wireless connection with said hardware component, said connection sequence for transmission to said hardware component via a short-range wireless transmitter of said computing device; and
an application program stored in said non-transitory memory of said computing device, that, upon execution by said processor of said computing device, causes said processor to allow a user to remotely control said hardware component using an application interface of said application program.

11. The system as defined in claim 10, wherein said hardware component comprises a remote, and wherein said generating is for establishing a short-range wireless connection with said remote of said hardware component, said connection sequence for transmission to said remote of said hardware component via said short-range wireless transmitter of said computing device.

12. The system as defined in claim 11, further comprising said remote for actuating said hardware component comprising:
memory;
a processor;
a short-range wireless transmitter;
a short-range wireless receiver; and
program code stored in said memory of said remote that, when executed by said processor of said remote, causes said processor to generate periodically said identity sequence of said remote that is broadcast by said short-range wireless transmitter.

13. The system as defined in claim 11 or claim 12, wherein said remote is integrated in said hardware component.

14. The system as defined in claim 11 or claim 12, wherein said remote comprises an additional wireless transmitter, and wherein said system further comprises a receiver antenna adapted to be paired with said additional wireless transmitter of said remote.

15. The system as defined in claim 11, wherein said short-range wireless receiver of said remote and said short-range wireless transmitter of said remote are part of a short-range wireless transceiver of said remote.

16. The system as defined in any one of claims 10 to 15, wherein said computing device comprises instructions of said application program stored in memory of said computing device, that when executed by the processor of said computing device, cause said computing device to listen for said identity sequence generated by said hardware component and received by said short-range wireless receiver of said computing device, said identity sequence transmitted to said background process, and wherein said listening is performed by generating a filter at a level of an operating system of said computing device.

17. The system as defined in any one of claims 10 to 16, wherein said short-range wireless connection is a Bluetooth connection.

18. The system as defined in any one of claims 10 to 17, wherein said hardware component is a remote starter unit of a vehicle, and wherein said application program is adapted to generate a command following the receipt of user input for causing the remote starting of said vehicle.

19. The system as defined in any one of claims 10 to 18, wherein said background process is part of said application program.

20. The system as defined in any one of claims 10 to 19, wherein said background process further causes said processor of said computing device to transmit, upon receipt by said background process of a message generated by said hardware component, instructions to an operating system of said computing device to generate a notification on a display of said computing device, said notification corresponding with said received message.

21. A system for establishing a short-range wireless connection between a remote, for controlling a remote vehicle starting unit installed in a vehicle, and a computing device comprising a background process for causing the establishment of a short-range wireless connection with said remote, such that a user's waiting time for using the computing device to send commands to the remote is reduced, comprising:
a remote for actuating said remote vehicle starting unit comprising:
memory;
a processor;
a first short-range wireless transmitter;
a first short-range wireless receiver;
a second wireless transmitter; and
program code stored in said memory of said remote that, when executed by said processor of said remote, causes said processor to generate periodically an identity sequence of said remote that is broadcast by said first short-range wireless transmitter;
an antenna, for installation in said vehicle, adapted to be paired with said second wireless transmitter of said remote;
a background process stored in memory of said computing device, that, upon execution by a processor of said computing device, causes said processor of said computing device to:
upon receiving an identity sequence generated by said remote, generate a connection sequence for establishing a short-range wireless connection with said remote, said connection sequence for transmission to said remote via a short-range wireless transmitter of said computing device; and
an application program comprising instructions stored in memory of the computing device and, when executed by the processor of the computing device:
allows a user to remotely start said vehicle via said remote vehicle starting unit using an application interface of said application program; and
causes said computing device to listen for said identity sequence generated by said remote and received by said short-range wireless receiver of said computing device, said identity sequence transmitted to said background process.

22. The system as defined in claim 21, wherein said listening is performed by generating a filter at a level of an operating system of said computing device
